(19) United States
(12) Patent Application Publication
(10) Pub. No.: US 2010/0127688 A1
(43) Pub. Date: May 27, 2010

(54) CURRENT LOAD DRIVING DEVICE

(75) Inventor: Yasuchika Konishi, Kusatsu-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/625,483

(22) Filed: Nov. 24, 2009

(30) Foreign Application Priority Data
Nov. 25, 2008 (JP) 2008-299196

(51) Int. Cl. G05F 3/02

(52) U.S. Cl. 323/312

(57) ABSTRACT

A current load driving device includes a power supply terminal connected to a power supply line, an earth terminal connected to an earth line, one or more output terminals, a constant voltage source, a control unit, a current output unit, and a command unit. The constant voltage source supplies constant voltage to the control unit. The control unit outputs a control current to the current output unit so that a voltage between the power supply line and the earth line becomes a target voltage and stops the output of the control current if the voltage between the power supply line and the earth line does not reach the target voltage. The command unit provides a signal for switching ON and OFF the control current output to the current output unit. The current output unit increases or decreases a current to output to the output terminal.

### BACKGROUND OF THE INVENTION

1. Technical Field

The present invention relates to current load driving devices and, more specifically, to a current load driving device used as a detection device and the like for driving a current load (external load) by a detection output of a proximity sensor and the like.

2. Related Art

(Double-Wire System and Three-Wire System)

In automated machining devices and the like, a detection device for monitoring an operation and a state of various tools is arranged, where a signal is outputted from the detection device to an external load such as a machine tool when a sensor detects abnormality and the like of various tools.

The detection device (current load driving device) for driving the current load by the detection output of the sensor includes a three-wire system in which a power supply terminal, an output terminal, and an earth terminal are arranged, and a double-wire system in which the power supply terminal and the output terminal are commonly used and the power supply terminal and the earth terminal are arranged.

The detection device of the three-wire system includes the power supply terminal, the output terminal, and the earth terminal, where a power supply is connected between the power supply terminal and the earth terminal, and an external load is connected between the output terminal and the earth terminal. The detection device of the double-wire system commonly uses the power supply terminal with the output terminal, where the power supply and the external load are connected in series between the power supply terminal and the earth terminal.

The detection device of the double-wire system has a merit of saving wiring since the external load is connected in series with the detection device. This merit of saving wiring is large particularly when the external load and the power supply are positioned distant from the detection device. In the double-wire system, however, the power supply voltage is consumed in a divided manner by the external load and the detection device, and thus the voltage for the detection device itself to operate normally cannot be obtained due to voltage drop if the external load has a large current consumption. Thus, in the detection device of the double-wire system, the output current needs to be controlled so that the drive current of the external load does not become too large, and hence an application is limited. Therefore, a detection device of the three-wire system is also necessary apart from the detection device of the double-wire system in related art.

However, if the detection device of the double-wire system and the detection device of the three-wire system are separately provided, the cost of the detection device rises as a result of increase in type. Thus, a detection device that can respond to both the double-wire system and the three-wire system having different drive circuits is desired.

(Double-Wire/Three-Wire Sharing System)

Japanese Patent No. 3488034 discloses a detection device capable of responding to both the double-wire system and the three-wire system. FIG. 1 is a block diagram showing such a detection device, where reference numeral 1 indicates a detector, 2 indicates an output circuit, 3 indicates a power supply terminal, 4 indicates an output terminal, 5 indicates an earth terminal, 6 indicates a double-wire/three-wire switching unit, 6a indicates an input terminal, 6b indicates a three-wire side output terminal, 6c indicates a double-wire side output terminal, 6d indicates a switching terminal, 7 indicates a current amplifier unit, 8 indicates an output driver unit, 9 indicates a reference voltage generation unit, 10 indicates a current setting unit, 11 indicates a sensor, 12 indicates a resistor, and 13 indicates a comparator.

When using as the double-wire system in such a detection device, if the switching terminal 6d of the double-wire/three-wire switching unit 6 is opened, the three-wire side output terminal 6b opens and the double-wire side output terminal 6c closes in conjunction therewith. The power supply terminal 3 and the output terminal 4 are short-circuit connected, and the external load and the power supply are connected in series between the power supply terminal 3 (output terminal 4) and the earth terminal 5. When the switching terminal 6d is opened, the input terminal 6a is connected to the double-wire side output terminal 6c to validate the current setting unit 10, whereby the current setting unit 10 adjusts the current to supply to the current amplifier unit 7 so that the input voltage Vcc of the power supply terminal 3 does not become lower than the reference voltage Vref outputted from the reference voltage generation unit 9 to suppress the voltage drop of the external load and ensure the voltage at which the detection device normally operates.

When using as the three-wire system, if the switching terminal 6d of the double-wire/three-wire switching unit 6 is closed, the three-wire side output terminal 6b closes and the double-wire side output terminal 6c opens in conjunction therewith. The power supply is connected between the power supply terminal 3 and the earth terminal 5, and the external load is connected between the output terminal 4 and the earth terminal 5.

Thus, in the detection device disclosed in Japanese Patent No. 3488034, the double-wire/three-wire switching unit 6 for setting whether to use as the double-wire system or to use as the three-wire system is arranged, where the switching terminal 6d is switched to open when using as the double-wire system and the switching terminal 6d is switched to close when using as the three-wire system by hand. Thus, the setting of the switching terminal 6d may not match the manner of connecting the external load and the power supply due to man-caused setting mistake, and the detection device may not normally operate.

### SUMMARY

One or more embodiments of the present invention provide a current load driving device that automatically switches to the circuit of the double-wire system or the three-wire system depending on the manner of connecting the power supply and the external load.

In accordance with one aspect of the present invention, a current load driving device includes a power supply terminal connected to a power supply line, an earth terminal connected to an earth line, one or a plurality of output terminals, a constant voltage source, a control unit, a current output unit, and a command unit, wherein the constant voltage source supplies constant voltage to the control unit; the control unit outputs a control current to the current output unit so that a voltage between the power supply line and the earth line becomes a target voltage, which is a constant multiple of the constant voltage, and stops the output of the control current if the voltage between the power supply line and the earth line does not reach the target voltage; the command unit provides a signal for switching ON and OFF the current output to the current output unit; and the current output unit increases or decreases the current to output to the output terminal according to the control current from the control unit, and outputs a current of a constant value if the output of the control current is stopped, the current output to the output terminal being switched to ON or OFF by the signal of the command unit.

The current load driving device of the present invention can switch ON/OFF the output current of the current output unit by the signal outputted from the command unit, so that the output current from the current output unit to the external load can be turned ON/OFF (or OFF/ON) according to the detection/non-detection of the object etc., and the operation of the external load can be changed according to the detection/non-detection of the object.

The control unit of the current load driving device of the present invention outputs the control current to the current output unit so that the voltage Vcc between the power supply line and the earth line becomes a target voltage VA, which is a constant multiple of the constant voltage VB from the constant voltage source, so that the voltage Vcc of the power supply line is maintained at a predetermined constant voltage VA and the voltage necessary to drive the current load driving device is ensured when the power supply terminal and the output terminal are short circuited, and the external load and the power supply are connected in series between the power supply terminal and the earth terminal (double-wire system). The control current is not outputted to the current output unit if control cannot be made so that the voltage Vcc between the power supply line and the earth line is equal to the target voltage VA, whereby the voltage Vcc of the power supply line is maintained at the voltage of the power supply and the voltage necessary to drive the current load driving device is ensured when the power supply is connected between the power supply terminal and the earth terminal and the external load is connected between the power supply terminal and the output terminal (three-wire system). According to the current load driving device of the present invention, the current load driving device can be switched to the double-wire system or the three-wire system depending on whether the manner of connecting the external load and the power supply to be connected to the power supply terminal, the output terminal, and the earth terminal is the double-wire system or the three-wire system without operating the internal switch, the internal wiring, and the like of the current driving device. Therefore, operation failure of the current load driving device due to the setting mistake of the current load driving device as in the related art does not occur.

In an aspect of the current load driving device according to the present invention, the control unit includes a voltage dividing portion for dividing the voltage between the power supply line and the earth line, a differential amplifier having the constant voltage from the constant voltage source supplied to a non-inverted input terminal and a voltage divided by the voltage dividing portion supplied to an inverted input terminal, and a transistor having the output of the differential amplifier connected to a base. According to such an aspect, the control current for controlling such that the voltage of the power supply line becomes equal to the predetermined voltage can be generated by comparing the voltage of the power supply line divided by the voltage dividing portion and the constant voltage supplied from the constant voltage source.

In the above aspect, the constant voltage source may include a band gap circuit for outputting a constant voltage to the control unit, and a constant voltage circuit for supplying a constant voltage to the band gap circuit. According to such a constant voltage source, the stability of the constant voltage outputted from the constant voltage source can be enhanced since the constant voltage is outputted from the band gap circuit by the constant voltage supplied from the constant voltage circuit.

Another aspect of the current load driving device according to the present invention includes one of the output terminals for directly connecting an external load, wherein the current output unit is configured to directly supply the current output to the external load. According to such an aspect, the external load and the power supply can be directly connected to the power supply terminal, the output terminal, and the earth terminal in the double-wire system or the three-wire system.

Still another aspect of the current load driving device according to the present invention includes two output terminals, wherein the current output unit is configured to supply the current output to an external load through an NPN-type external attachment transistor connected to one output terminal, and supply the current output to the external load through an PNP-type external attachment transistor connected to the other output terminal. According to such an aspect, when connecting the external load and the power supply in the three-wire system, either to connect the external load to one output terminal through the NPN-type external attachment transistor (NPN output method) or to connect the external load to the other output terminal through the PNP-type external attachment transistor (PNP output method) can be selected depending on the type of external load.

The means for solving the problems of the present invention have features in which the above-described components are appropriately combined, and the present invention enables many variations by combination of components.

### BRIEF DESCRIPTION OF THE DRAWINGS

FIG. 1 is a block diagram showing a detection device described in Japanese Patent No. 3488034;

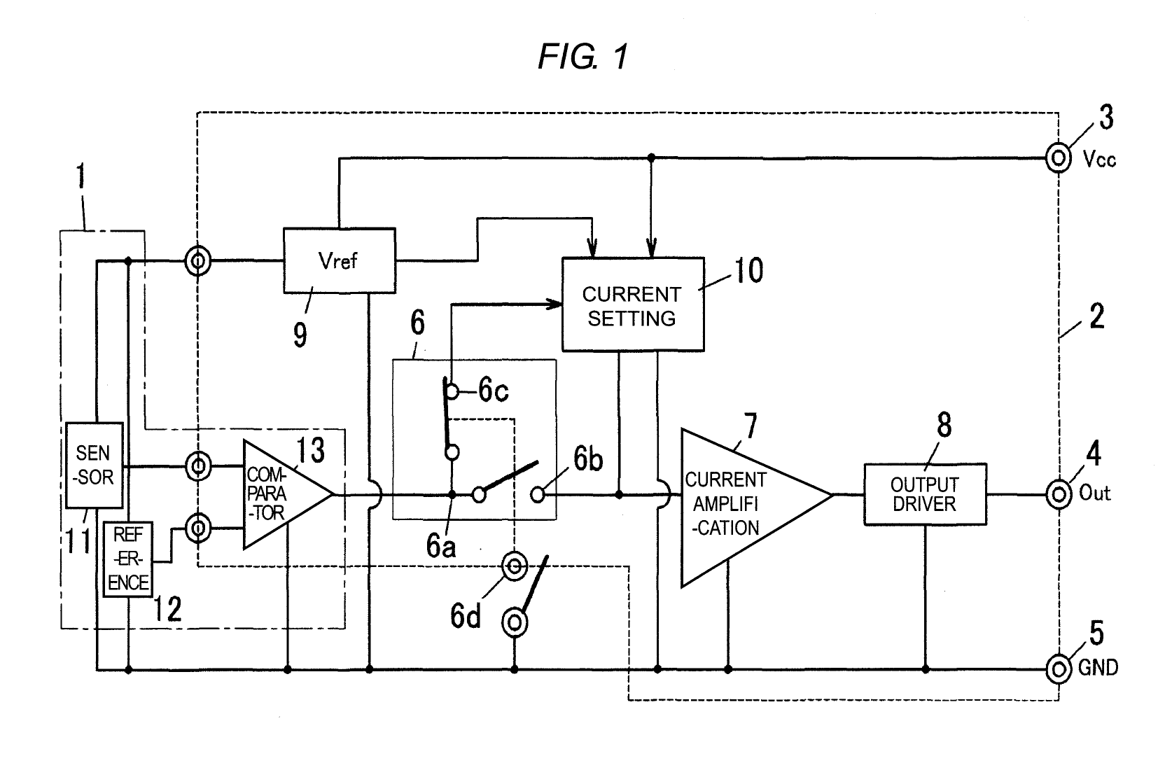

FIG. 2A is a block diagram of a current load driving device according to a first embodiment of the present invention, FIG. 2B is a block diagram showing a case in which an external load and a power supply are connected to the current load driving device in a double-wire system, and FIG. 2C is a block diagram showing a case in which the external load and the power supply are connected to the current load driving device in a three-wire system;

FIG. 3 is a specific circuit diagram of a case using the current load driving device of the first embodiment in the double-wire system;

FIG. 4 is a specific circuit diagram of a case using the current load driving device of the first embodiment in the three-wire system;

FIG. 5 is a view specifically showing the configuration of a command unit;

FIG. 6 is a view showing a specific circuit for turning ON or OFF the current output unit by a signal Is from the command unit;

FIG. 7 is a specific circuit diagram of a case using a current load driving device of a second embodiment in the three-wire system;

FIG. 8 is a specific circuit diagram showing another configuration of using the current load driving device of the second embodiment in the three-wire system; and

FIG. 9 is a specific circuit diagram of a case using the current load driving device of the second embodiment in the double-wire system.

### DETAILED DESCRIPTION

Hereinafter, embodiments of the present invention will be described with reference to the drawings.

### First Embodiment

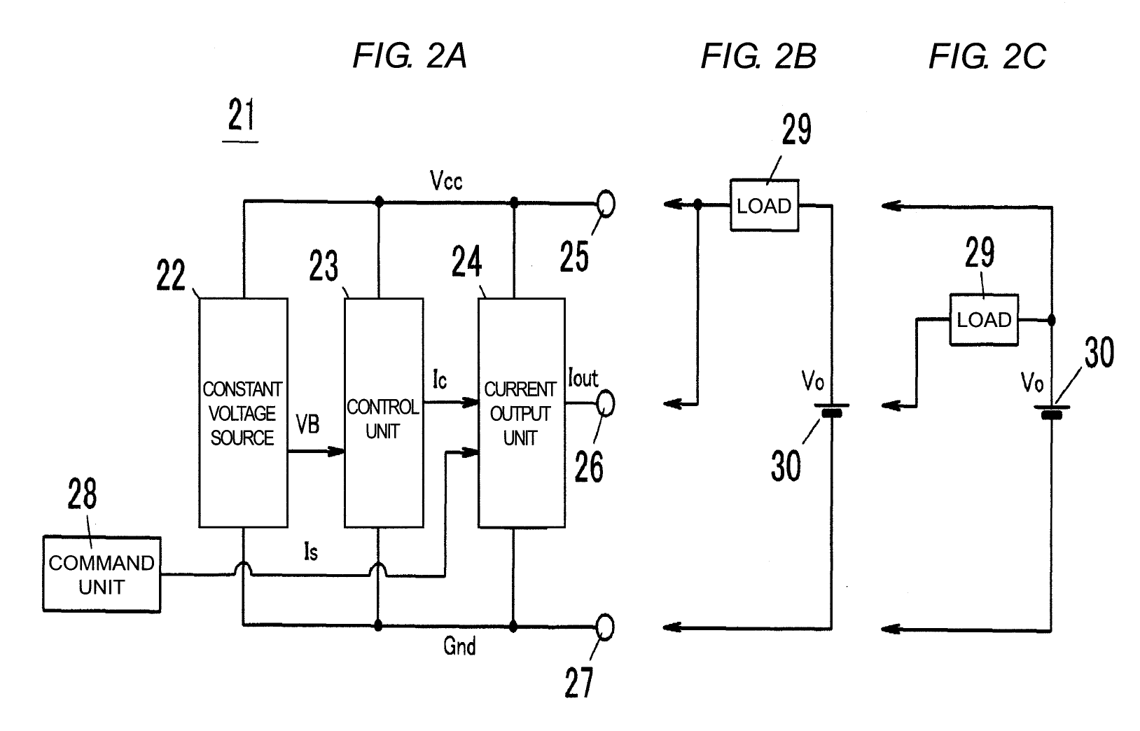

A first embodiment of the present invention will be described with reference to FIGS. 2 to 6. FIG. 2A is a block diagram of a current load driving device 1 according to the first embodiment of the present invention. FIGS. 2B and 2C show a wiring state in the case of connecting an external load 29 (current load) and a power supply 30 to the current load driving device 21 in the double-wire system, and the case of connecting the same in the three-wire system, respectively.

As shown in FIG. 2A, the current load driving device 21 is configured by a constant voltage source 22, a control unit 23, a current output unit 24, a power supply terminal 25, an output terminal 26, an earth terminal 27, and a command unit 28. The constant voltage source 22, the control unit 23, and the current output unit 24 are connected in parallel to each other between a power supply line connected to the power supply terminal 25 and an earth line connected to the earth terminal 27.

The constant voltage source 22 supplies a constant voltage VB to the control unit 23. The control unit 23 outputs a control current Ic to the current output unit 24 so that the voltage Vcc of the power supply line becomes a voltage VA, which is a constant multiple of the constant voltage VB. In this case, Vcc=VA=kVB (k is a constant). However, if the voltage Vcc does not change even if the control unit 23 attempts to adjust the voltage Vcc of the power supply line to VA, the control unit 23 turns OFF the control current Ic (i.e., Ic=0 ampere).

The output of the current output unit 24 is connected to the output terminal 26, and the current output unit 24 outputs the current Iout corresponding to the value of the control current Ic to the output terminal 26. The output current Iout changes by the control current Ic from the control unit 23, but does not become 0 ampere (Iout≠0 ampere), and the output current Iout monotonously increases or decreases with increase or decrease of the control current Ic. If the control current Ic is turned OFF, however, the current output unit 24 outputs a constant current Iout (≠0 ampere) to the output terminal 26.

The command unit 28 outputs a signal Is for switching ON and OFF of the output of the current output unit 24 to the current output unit 24. The current output unit 24 outputs the current Iout, which is not 0 ampere, according to the value of the control current Ic when the output is turned ON by the signal Is from the command unit 28, and the current is not outputted to the output terminal 26 (i.e., Iout=0 ampere) regardless of the value of the control current Ic if the output is turned OFF by the signal Is.

When connecting the external load 29 and the power supply 30 to the current load driving device 21 in the double-wire system, the power supply terminal 25 and the output terminal 26 are connected to be short circuited, and the external load 29 and the power supply 30 that are connected in series are connected between the power supply terminal 25 and the earth terminal 27, as shown in FIG. 2B.

In the case of the double-wire system, the voltage Vcc of the power supply line is controlled by the control unit 23 to become the constant voltage VA=kVB. Thus, the control current Ic having the value corresponding to the resistance value of the external load 29 is outputted from the control unit 23 to the current output unit 24. When the output of the current output unit 24 is turned ON by the signal Is from the command unit 28, the current Iout (≠0 ampere) corresponding to the value of the control current Ic is outputted from the output of the current output unit 24 to the external load 29. When the output of the current output unit 24 is turned OFF by the signal Is from the command unit 28, the current does not flow from the output of the current output unit 24 to the external load 29 (Iout=0 ampere).

When connecting the external load 29 and the power supply 30 to the current load driving device 21 in the three-wire system, the external load 29 is connected between the power supply terminal 25 and the output terminal 26, and the power supply 30 is connected between the power supply terminal 25 and the earth terminal 27, as shown in FIG. 2C.

In the case of the three-wire system, the voltage Vcc of the power supply line becomes equal to the voltage Vo of the power supply 30, and the voltage Vcc of the power supply line cannot be controlled to become the constant voltage VA=kVB by the control unit 23, and thus the control current Ic outputted from the control unit 23 to the current output unit 24 is turned OFF (0 ampere). When the output of the current output unit 24 is turned ON with the signal Is from the command unit 28, a constant current Iout (≠0 ampere) is outputted from the output of the current output unit 24 to the external load 29. When the output of the current output unit 24 is turned OFF with the signal Is from the command unit 28, current does not flow (Iout=0 ampere) from the output of the current output unit 24 to the external load 29.

In the current load driving device 21 described above, use can also be made as a double-wire system that can save wiring. When used as the double-wire system, the voltage Vcc of the power supply line is maintained at a constant voltage set in advance by the action of the control unit so that the current load driving device 21 does not cause operation failure due to lack of voltage Vcc. In other words, when the load of the external load 29 is large, the values of the control current Ic and the output current Iout change thereby reducing the current to flow to the external load 29, whereby the voltage Vcc of the power supply line can be maintained constant.

According to the above current load driving device 21, the double-wire system and the three-wire system can be switched by simply changing the manner of connecting the external load 29, the power supply 30, and the like to connect to the power supply terminal 25, the output terminal 26, and the earth terminal 27 of the current load driving device 21, and hence switch switching, changing of internal wiring, and the like of the current load driving device 21 itself do not need to be performed, and operation failure of the current load driving device 21 due to difference in the manner of connecting the external load and the power supply and the manner of setting the current load driving device as in the related art does not occur.

Furthermore, according to the current load driving device 21, the accuracy of the control target value is high as the voltage VA=kVB, which is a constant multiple of the output VB of the constant voltage source 22, is the control target of the power supply line voltage in the case of the double-wire system.

(Specific Circuit)

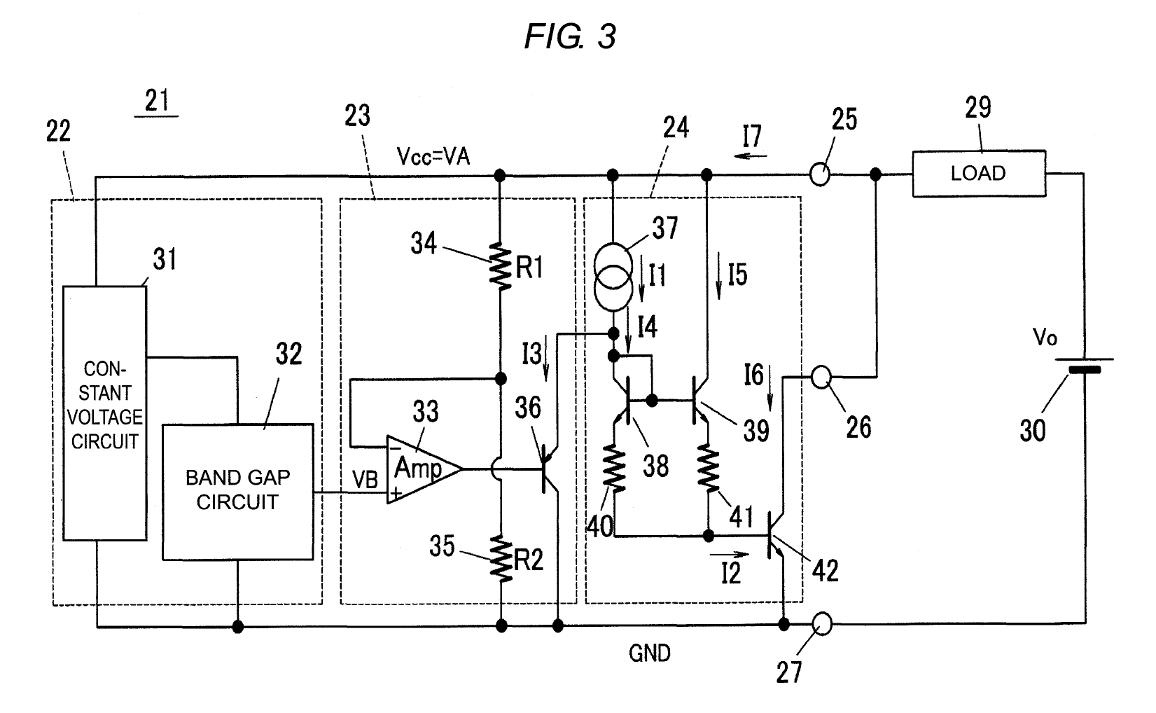

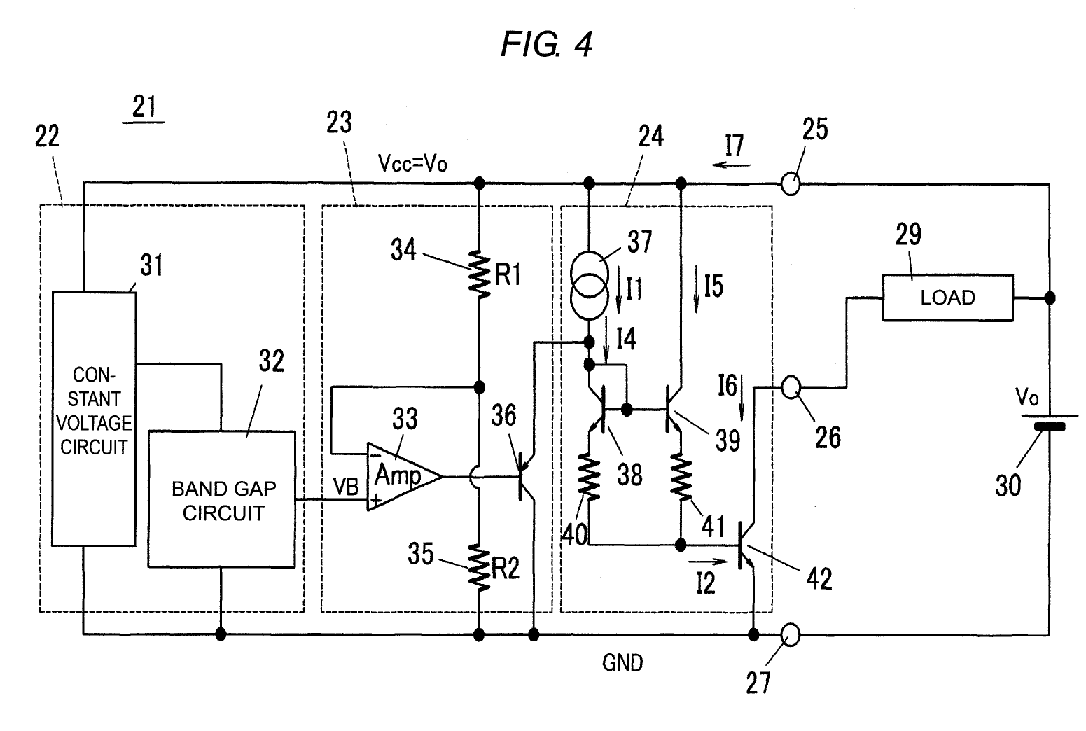

FIGS. 3 and 4 are views showing an example of a specific circuit of the current load driving device 21 shown in FIG. 2, where FIG. 3 shows a case where the external load 29 and the power supply 30 are connected in the double-wire system, and FIG. 4 shows a case where the external load 29 and the power supply 30 are connected in the three-wire system. In FIGS. 3 and 4, the command unit 28 is omitted (when the output of the current output unit 24 is turned ON).

First, a case of the current load driving device 21 in which the external load 29 and the power supply 30 are connected in the double-wire system will be described with reference to FIG. 3. The constant voltage source 22 is configured by a constant voltage circuit 31 connected between the power supply line and the earth line, and a band gap circuit 32 for receiving the output of the constant voltage circuit 31, where the band gap circuit 32 is driven with a constant voltage outputted from the constant voltage circuit 31 to output the constant voltage VB from the band gap circuit 32.

The control unit 23 is configured by an operational amplifier 33 (differential amplifier), voltage dividing resistors 34, 35, and a PNP-type transistor 36. The voltage dividing resistors 34, 35 are connected in series and are connected between the power supply line and the earth line (voltage dividing portion). A midpoint voltage of the voltage dividing resistors 34, 35 is inputted to an inverted input terminal of the operational amplifier 33, and a constant voltage VB outputted from the constant voltage source 22 is inputted to the non-inverted input terminal.

The voltage Vcc of the power supply line is maintained at a constant voltage proportional to the constant voltage VB in the following manner by the action of the control unit 23 having the above configuration. Assuming each resistance value of the voltage dividing resistors 34, 35 is R1, R2 and the voltage of the power supply line is Vcc, the midpoint voltage of the voltage dividing resistors 34, 35 is R2×Vcc/(R1+R2). Since the inverted input terminal voltage and the non-inverted input terminal voltage of the operational amplifier 33 applied with negative feedback are equal, R2×Vcc/(R1+R2)=VB is obtained. Thus, the voltage Vcc of the power supply line is controlled so as to become the constant voltage VA proportional to the constant voltage VB by the control unit 23.

VA=Vcc=(R1+R2)×VB/R2 (Equation 1)

The transistor 36 has the base connected to the output terminal of the operational amplifier 33, the emitter connected to the current output unit 24, and the collector connected to the earth line. As the current flows from the emitter of the transistor 36 to the output terminal of the operational amplifier 33, the transistor 36 is turned ON and the control current Ic (=−I3) flows to the emitter of the transistor 36.

The current output unit 24 is configured by a constant current source 37, transistors 38, 39, resistors 40, 41, and an output transistor 42. A current mirror circuit is configured by connecting the respective bases of the NPN-type transistor 38 and the NPN-type transistor 39, and short circuiting the collector and the base of the transistor 38. The constant current source 37 having an output current I1 is connected between the power supply line and the collector of the transistor 38, and the control unit 23 (emitter of transistor 36) is connected to the collector of the transistor 38. The collector of the transistor 39 is connected to the power supply line. The emitter of the transistor 38 is connected to the base of the NPN-type output transistor 42 by way of the resistor 40, and the emitter of the transistor 39 is also connected to the base of the NPN-type output transistor 42 by way of the resistor 41. The emitter of the output transistor 42 is connected to the earth line, and the collector is connected to the output terminal 26.

The power supply terminal 25 and the output terminal 26 are short circuited, the external load 29 and the power supply 30 are connected in series and have the ends connected to the power supply terminal 25 and the earth terminal 27.

As shown in FIG. 3, the output current of the constant current source 37 is I1, the base current of the output transistor 42 is I2, the emitter current of the transistor 36 is I3 (=−Ic), the current flowing from the constant current source 37 to the current mirror circuit (transistors 38, 39) is I4, the collector current of the transistor 39 is I5, the collector current of the output transistor 42 flowing in from the output terminal 26 is I6 (=−Iout), and the current flowing in from the power supply terminal 25 is I7. The current values have the following relationship.

I7=I1+I5

I1=I3+I4

I5=αI4 (α: amplification coefficient determined by transistors 38, 39 and resistors 40, 41)

I2=I4+I5=(1+α)I4

I6=βI2 (β: amplification factor of output transistor 42)

VA−Vo=(I6+I7)R (R: resistance value of external load 39) (Equation 2)

Therefore,

I6=β(1+α)(I1−I3)

OR

Iout=−β(1+α)(Ic+I1) (Equation 3)

is obtained.

According to equations 1 to 3, in the case of the double-wire system, the control current Ic (=−I3) of the control unit 23 changes if the resistance value R of the external load 29 differs, and thus the voltage Vcc of the power supply line can be maintained at the constant voltage VA regardless of the resistance value R of the external load 29.

Specifically describing, when the voltage Vcc of the power supply line becomes greater than VA, the voltage of the inverted input terminal of the operational amplifier 33 becomes higher than the voltage VB of the non-inverted input terminal, and thus the base current of the transistor 36 reduces and the emitter current I3 of the transistor 36 also reduces. Therefore, the current taken out from the constant current source 37 reduces, and the base current I2 of the output transistor 42 increases. As a result, the collector current I6 of the output transistor 42 increases and the voltage Vcc of the power supply line is lowered. When the voltage Vcc of the power supply line becomes smaller than VA, the collector current I6 of the output transistor 42 reduces and the voltage Vcc of the power supply line becomes high. The voltage Vcc of the power supply line then stabilizes in a state equal to VA=(R1+R2)×VB/R2.

When the resistance value R of the external load 29 becomes large, the emitter current I3 of the transistor 36 increases, and the collector current of the output transistor 42 decreases thereby maintaining the voltage drop by the external load 29 to a constant, so that lack of voltage does not occur in the current load driving device 21.

A case of the current load driving device 21 in which the external load 29 and the power supply 30 are connected in the three-wire system will be described with reference to FIG. 4. In this case, the external load 29 is connected between the power supply terminal 25 and the output terminal 26, and the power supply 30 is connected between the power supply terminal 25 and the earth terminal 27.

In the case of the three-wire system, the voltage Vcc of the power supply line becomes equal to the voltage Vo (normally, greater than or equal to 5 volts) of the power supply 30, and thus the voltage of the inverted input terminal of the operational amplifier 33 becomes a voltage divided by the voltage dividing resistors 34, 35, R2×Vo/(R1+R2)(>VB). Thus, the operational amplifier 33 becomes high impedance, and the transistor 36 is turned OFF. Therefore, the control current is Ic=−I3=0 ampere. As a result, the output current Iout of the current output unit 24 becomes the current defined by the current value I1 of the constant current source 37, that is, Iout=−I6=−β(1+α)I1, and the external load 29 is driven with such an output current Iout.

(Configuration of Command Unit)

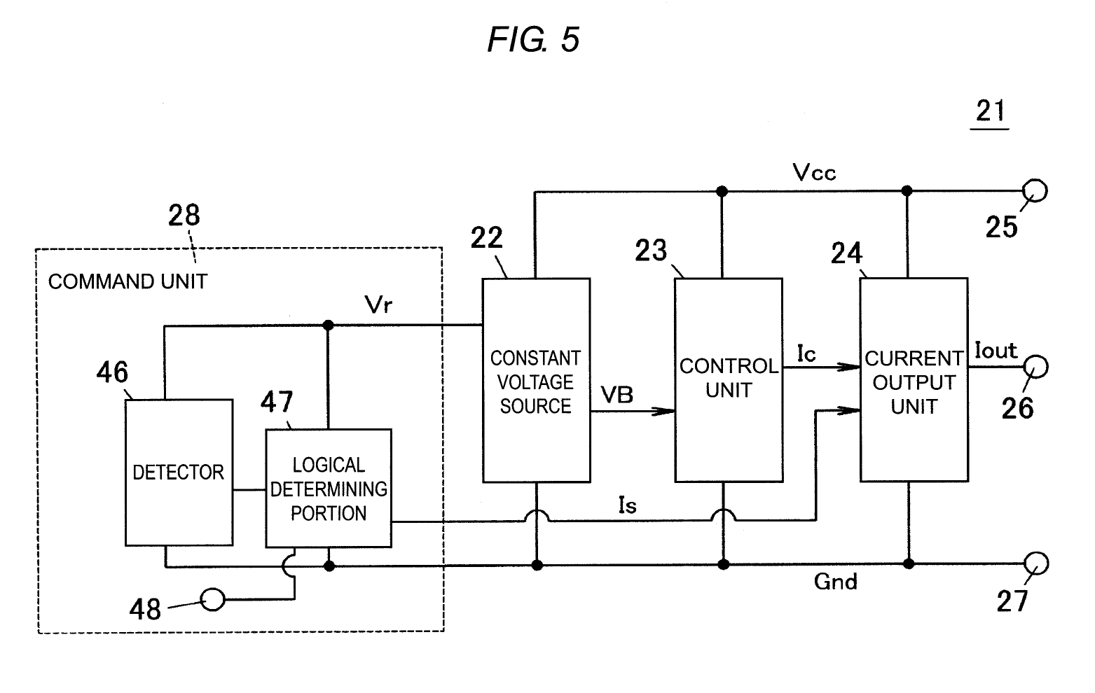

FIG. 5 shows a specific configuration of the command unit 28. The command unit 28 reads the signal from the detector 46 for detecting the presence of object, distance, and the like, determines detection/non-detection of the object and outputs a signal Is to the current output unit 24, and switches the output of the current output unit 24 to ON/OFF. The command unit 28 is configured by a detector 46 such as a proximity sensor or a distance measurement sensor, a logical determining portion 47, and a mode switching terminal 48, where the constant voltage Vr is supplied to the detector 46 and the logical determining portion 47 from the constant voltage source 22. The detector 46 transmits the signal to the logical determining portion 47 when detecting the presence of the object, the distance, and the like. The logical determining portion 47 includes the mode switching terminal 48 for switching between a normal open and a normal close, where switch can be made to output the ON signal Is when the detector 46 is in the detected state and to output the OFF signal Is when the detector 46 is in the non-detected state, or to output the OFF signal Is when the detector 46 is in the detected state and to output the ON signal Is when the detector 46 is in the non-detected state by switching High/Low of the signal to input to the mode switching terminal 48. The command unit 28 transmits the ON/OFF signal Is to the current output unit 24 at a mode set by the mode switching terminal 48 based on the signal of the detector 46.

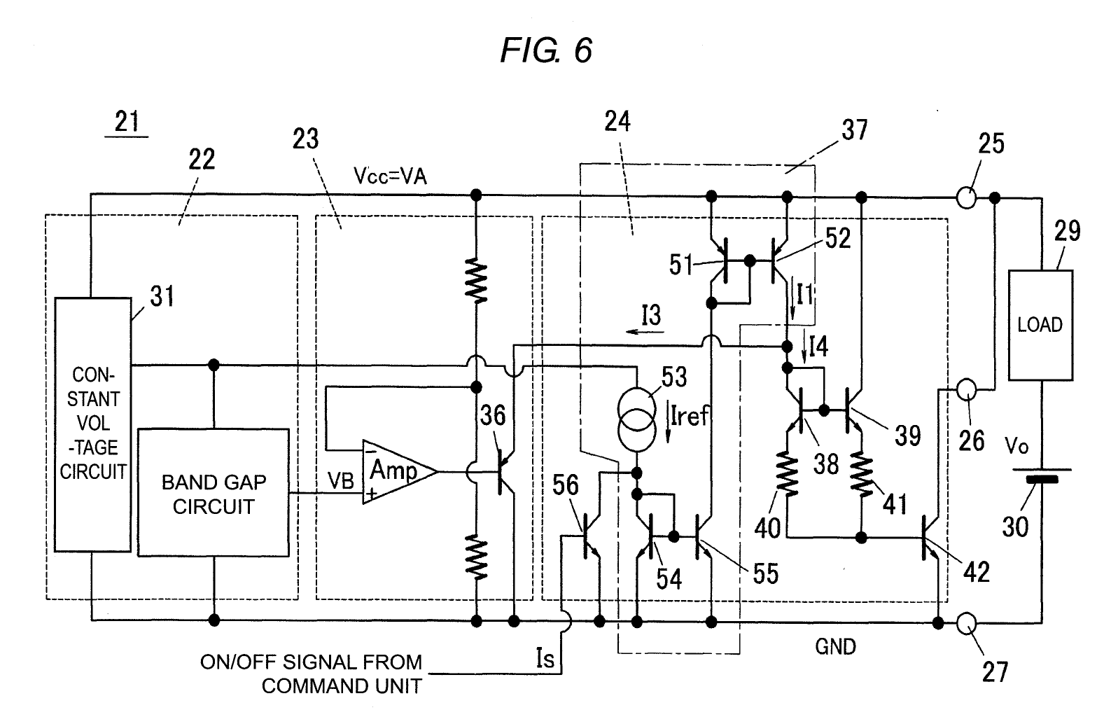

FIG. 6 shows a specific configuration for turning ON or OFF the output of the current output unit 24 by the ON/OFF signal Is from the command unit 28. In this specific example, the constant current source 37 is configured by a constant current source 53 having an output current of Ire, and a two-stage current mirror circuit. The current mirror circuit of the first stage is configured by PNP-type transistors 51, 52, where the base of the transistor 51 and the base of the transistor 52 are connected, and the base and the collector of the transistor 51 are short circuited. Each emitter of the transistors 51, 52 is connected to the power supply line, and the collector of the transistor 52 is the output of the constant current source 37 and is connected to the collector of the transistor 38 and the emitter of the transistor 36. The current mirror circuit of the second stage is configured by NPN-type transistors 54, 55, where the base of the transistor 54 and the base of the transistor 55 are connected, and the base and the collector of the transistor 54 are short circuited. Each emitter of the transistors 54, 55 is connected to the earth line, and the collector of the transistor 55 is connected to the collector of the transistor 51 of the current mirror circuit of the first stage. The voltage is supplied from the constant voltage circuit 31 to the constant current source 53, and the output of the constant current source 53 is connected to the collector of the transistor 54.

An NPN-type transistor 56 turns ON or OFF the output of the current output unit 24 by the ON/OFF signal Is of the command unit 28, and has the collector connected to the output of the constant current source 53, the emitter connected to the earth line, and the base inputted with the ON/OFF signal Is outputted from the command unit 28.

When the ON signal Is (signal of low level) is outputted from the command unit 28, the transistor 56 is turned OFF, and thus the current flows to the current mirror circuits of the first stage and the second stage and the current I1 flows from the constant current source 37, whereby the transistors 38, 39, 42 are turned ON, the output of the current output unit 24 becomes ON, and the output current Iout flows from the output terminal 26 to the external load 29. On the contrary, when the OFF signal Is (signal of high level) is outputted from the command unit 28, the transistor 56 is turned ON, and thus the current does not flow to the current mirror circuits of the first stage and the second stage and the current is not outputted from the constant current source 37. As a result, the output of the current output unit 24 becomes OFF, and the current does not flow between the output terminal 26 and the external load 29.

Therefore, the current is outputted or the current is not outputted from the output terminal 26 to the external load 29 depending on the detection or the non-detection in the command unit 28. The case of the double-wire system has been described in FIG. 6, but this is similar in the case of the three-wire system.

### Second Embodiment

A current load driving device according to a second embodiment of the present invention will now be described. The current load driving device of the second embodiment has the output terminal 26 at the collector position of the output transistor 42 divided into two to be arranged at the base position of the output transistor 42 and the collector position of the transistor 39, and an external attachment transistor is used in place of the output transistor 42, with respect to the current load driving device 21 show in FIG. 3 or FIG. 4.

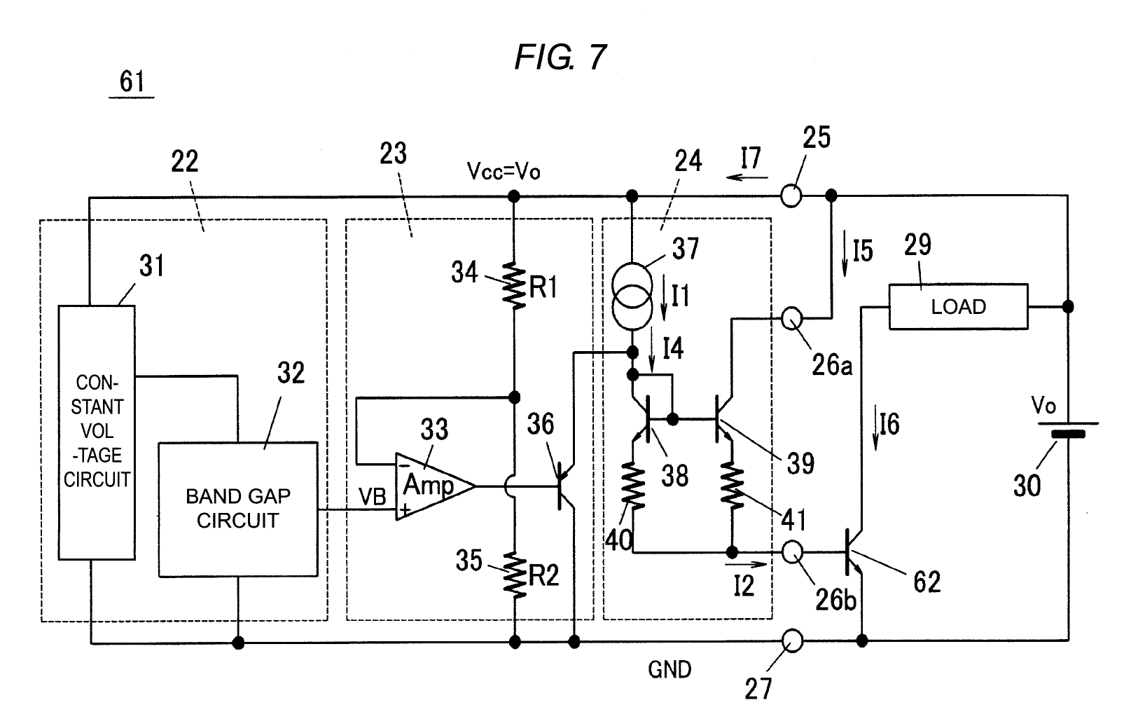

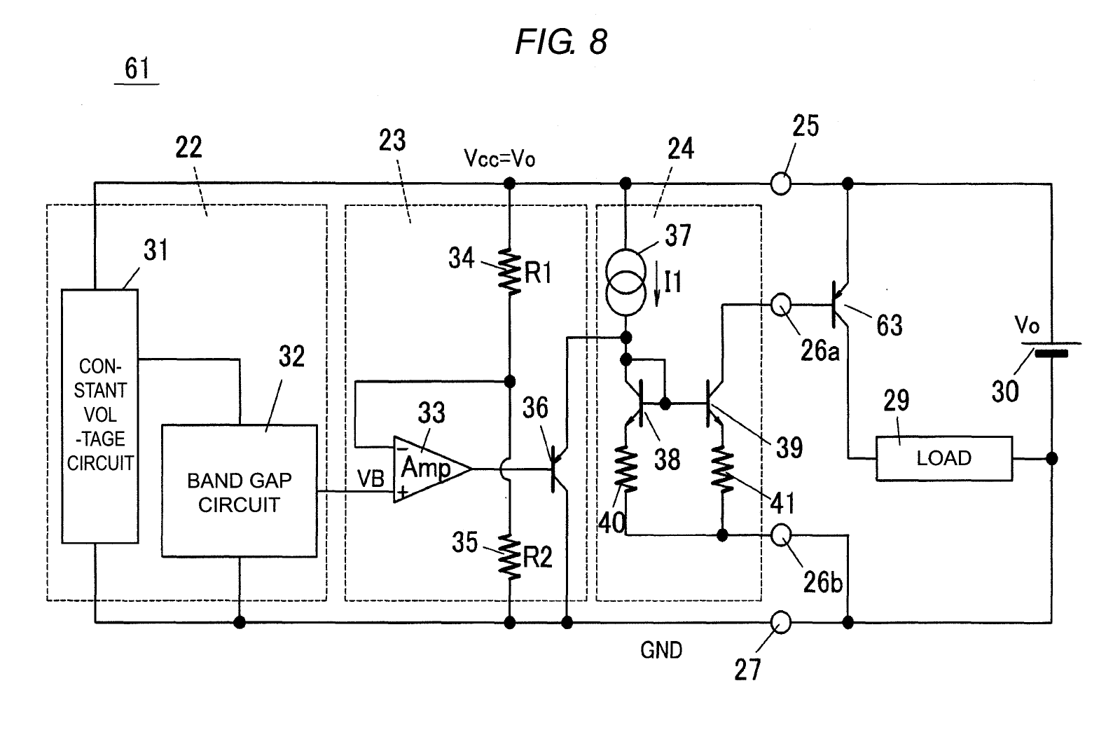

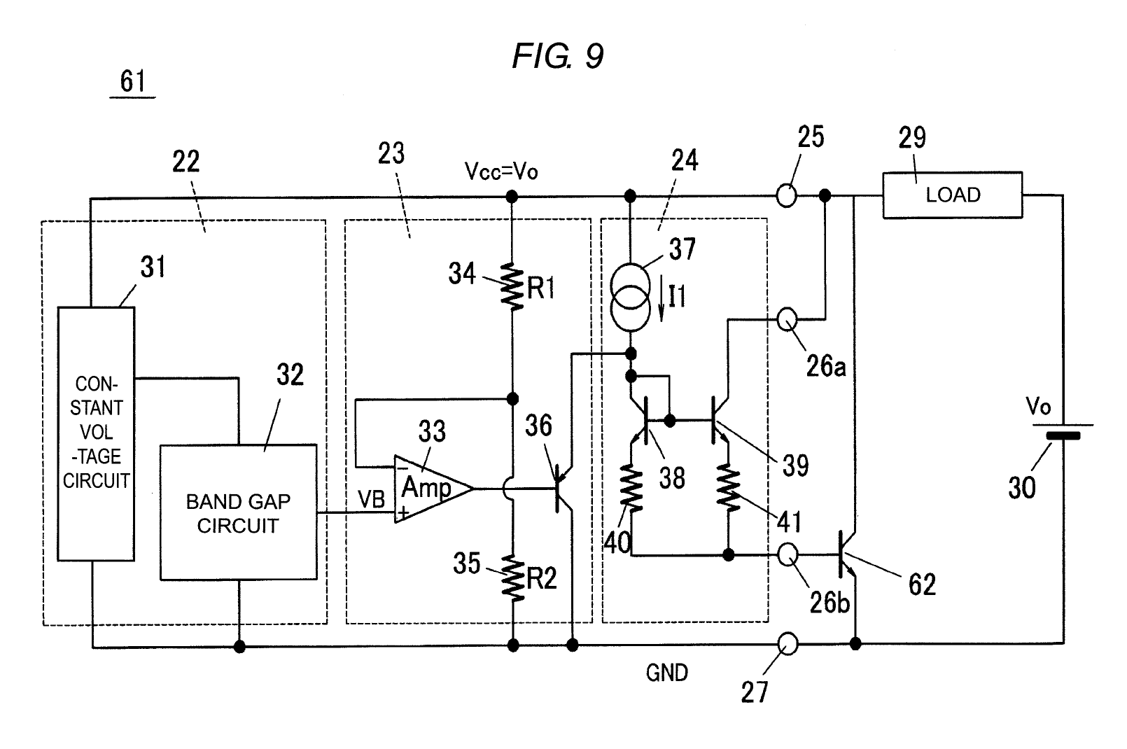

FIG. 7 shows a specific circuit of a case where the current load driving device 61 of the second embodiment is used in the three-wire system. Although the command unit 28 is omitted in FIG. 7 (similarly in FIGS. 8 and 9), the output of the current output unit 24 can be switched ON/OFF by connecting the command unit 28 to the current output unit 24 (see FIGS. 5 and 6).

In the relevant current load driving device 61, a first output terminal 26a is arranged at the collector position of the transistor 39, a second output terminal 26b is arranged at a wire connected portion of the resistors 40, 41, and the output transistor 42 of the first embodiment is excluded from the current output unit 24.

When using the current load driving device 61 in the three-wire system, the base of the NPN-type external attachment transistor 62 is connected to the second output terminal 26b and the emitter is connected to the earth terminal 27, as shown in FIG. 7. The first output terminal 26a is short circuited with the power supply terminal 25. The external load 29 is then connected between the power supply terminal 25 and the collector of the external attachment transistor 62, and the power supply 30 is connected between the power supply terminal 25 and the earth terminal 27. This is a circuit similar to FIG. 4.

When using the current load driving device 61 in the three-wire system, the base of the PNP-type external attachment transistor 63 is connected to the first output terminal 26a and the emitter is connected to the power supply terminal 25, as shown in FIG. 8. The second output terminal 26b is short circuited with the earth terminal 27. The external load 29 is then connected between the collector of the external attachment transistor 63 and the earth terminal 27, and the power supply 30 is connected between the power supply terminal 25 and the earth terminal 27.

Therefore, in the current load driving device 61 of the second embodiment, the NPN output method in which the NPN-type external attachment transistor 62 is externally attached, and the PNP output method in which the PNP-type external attachment transistor 63 is externally attached can be selected when used in the three-wire system.

Normally, the power supply voltage is greater than or equal to 5 volts in the three-wire system, where when the power supply voltage is directly inputted to both ends of the voltage dividing resistors 34, 35 connected in series as in FIG. 7 or FIG. 8, the inverted input terminal voltage of the operational amplifier 33 becomes greater than or equal to the output voltage VB (band gap voltage) of the band gap circuit 32, and the transistor 36 is turned OFF. The output current I1 of the constant current source 37 thus all flow to the output terminal 26a or 26b, and constant current is supplied to the NPN-type external attachment transistor 62 or the PNP-type external attachment transistor 63. The current flowing to the output terminals 26a, 26b is the constant current of constant multiple of the output current I1 of the constant current source 37, and thus the external attachment transistors 62, 63 can be operated without increasing the circuit current more than necessary.

When using the current load driving device 61 of the second embodiment in the double-wire system, the base of the NPN-type external attachment transistor 62 is connected to the second output terminal 26b and the emitter is connected to the earth terminal 27, as shown in FIG. 9. The first output terminal 26a is short circuited with the power supply terminal 25. The external load 29 and the power supply 30 connected in series are connected between the power supply terminal 25 and the earth terminal 27. This is a circuit similar to FIG. 3.

Therefore, according to the current load driving device 61 of the first embodiment, the external load 29 and the power supply 30 can be connected with either the double-wire system or the three-wire system, and furthermore, the NPN output method using the NPN-type external attachment transistor 62 and the PNP output method using the PNP-type external attachment transistor 63 can be used when connecting with the three-wire system.

1. A current load driving device comprising:
a power supply terminal connected to a power supply line;
an earth terminal connected to an earth line;
one or more or a plurality of output terminals;
a constant voltage source;
a control unit;
a current output unit; and
a command unit, wherein
the constant voltage source supplies constant voltage to the control unit;
the control unit outputs a control current to the current output unit so that a voltage between the power supply line and the earth line becomes a target voltage, and stops the output of the control current if the voltage between the power supply line and the earth line does not reach the target voltage, the target voltage being a constant multiple of the constant voltage;
the command unit provides a signal for switching ON and OFF the control current output to the current output unit; and
the current output unit increases or decreases a current to output to the one or more output terminals according to the control current from the control unit, and outputs a current of a constant value if the output of the control current is stopped, the current output to the one or more output terminals being switched to ON or OFF by the signal of the command unit.

2. The current load driving device according to claim 1, wherein the control unit comprises;
a voltage dividing portion for dividing the voltage between the power supply line and the earth line;
a differential amplifier having the constant voltage from the constant voltage source supplied to a non-inverted input terminal and a voltage divided by the voltage dividing portion supplied to an inverted input terminal; and
a transistor having an output of the differential amplifier connected to a base.

3. The current load driving device according to claim 2, wherein the constant voltage source comprises:
a band gap circuit for outputting a constant voltage to the control unit; and
a constant voltage circuit for supplying a constant voltage to the band gap circuit.

4. The current load driving device according to claim 1,
wherein one of the one or more output terminals connects directly to an external load, and
wherein the current output unit is configured to directly supply the current output to the external load.

5. The current load driving device according to claim 1, further comprising two output terminals, wherein the current output unit is configured to supply the current output to an external load through an NPN-type external attachment transistor connected to one output terminal and supply the current output to the external load through an PNP-type external attachment transistor connected to the other output terminal.
